(19) United States
(12) Patent Application Publication
(10) Pub. No.: US 2013/0132288 A1
(43) Pub. Date: May 23, 2013

(54) METHOD FOR MANAGING INTELLECTUAL PROPERTY

(71) Applicants: So-ling Carmen NG, Albany, CA (US); Dexter Kam CHIN, Singapore (SG)

(72) Inventors: So-ling Carmen NG, Albany, CA (US); Dexter Kam CHIN, Singapore (SG)

(21) Appl. No.: 13/742,313

(22) Filed: Jan. 15, 2013

Related U.S. Application Data
(63) Continuation-in-part of application No. 12/030,887, filed on Feb. 14, 2008, now Pat. No. 8,380,548.
(60) Provisional application No. 60/889,936, filed on Apr. 24, 2007.
(60) Provisional application No. 60/889,937, filed on Feb. 15, 2007.

(51) Int. Cl. G06Q 10/00; G06Q 50/26

(52) U.S. Cl. CPC G06Q 10/00; G06Q 50/26
USPC 705/310

(57) ABSTRACT

A search algorithm is provided in an intellectual property (IP) management system for determining an optimal IP portfolio. The search algorithm generates and evaluates a plurality of IP portfolios using objective functions to find an optimal IP portfolio that most nearly optimizes at least one goal. The optimal IP portfolio may be used to automatically evaluate a new IP disclosure.

### CROSS-REFERENCE TO RELATED APPLICATIONS

This application is a continuation-in-part of U.S. patent application Ser. No. 12/030,887, filed Feb. 14, 2008, which claims the benefit of U.S. Provisional Application No. 60/889,937 entitled “System & Method for Docketing and Portfolio Management”, filed Feb. 15, 2007 and U.S. Provisional Application No. 60/889,936 entitled “System & Method for Managing Intellectual Property”, filed Apr. 24, 2007, all of which are hereby incorporated by reference in their entirety.

### FIELD OF THE INVENTION

The present invention relates generally to management of intellectual property.

### BACKGROUND

Intellectual property (IP) assets are very valuable in many fields of business. They have formed a major part of the group of intangible property assets which have gained increasing importance for corporations. Intellectual property comprises patents, trademarks, service marks, copyrights, trade secrets and other forms of proprietary knowledge.

Creating, developing and managing intellectual property to fully exploit its potential value has become a main goal for many IP rights owners, particularly large corporations. Current IP portfolio systems are typically managed manually and day-by-day by responsible IP personnel. The IP portfolio manager reviews the invention disclosure and rates the disclosure based on advice of team members. The rating will determine if the disclosure is to be filed as a patent application, closed (if no further action is deemed necessary) or published as a defensive publication. Such decisions are typically ad-hoc and prone to personal biases of the decision maker.

From the foregoing discussion, it is desirable to provide an improved system that can manage and optimize an IP portfolio based on objective valuation.

### SUMMARY

An implementation is provided for facilitating management of a portfolio of intellectual property (IP) assets. It further facilitates management of an IP portfolio employing results from an informed search algorithm, such as a genetic algorithm. In accordance with one aspect, a framework for managing a portfolio of IP assets comprises the step of generating an initial population of genomes, wherein a genome includes the step of modifying the population using a genetic algorithm until a terminating condition is satisfied to obtain at least one genome representing an optimal IP portfolio that optimizes at least one goal. A new IP disclosure may be automatically evaluated based on the optimal IP portfolio.

A framework for managing a portfolio of IP assets discloses the step of receiving user information and analytical data. The framework searches for an optimal IP portfolio based on the user information and analytical data using an informed search algorithm, wherein the optimal IP portfolio optimizes at least one goal. The framework may further include automatically evaluating a new IP disclosure based on the optimal IP portfolio.

These and other objects, along with advantages and features of the present framework herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the framework. In the following description, various embodiments of the present framework are described with reference to the following drawings, in which:

FIG. 1 shows an exemplary system for managing IP;

FIG. 2 shows an exemplary flowchart illustrating the operation of a genetic algorithm;

FIG. 3 shows an exemplary genome;

FIG. 4 shows an exemplary graphical output of an optimal patent strategy;

FIG. 5 shows an exemplary textual output of an optimal patent strategy;

FIG. 6 shows an exemplary application of the IP management system; and

FIG. 7 shows exemplary output reports.

### DETAILED DESCRIPTION

The present framework relates generally to a method and system for generating an optimal Intellectual Property (IP) portfolio. IP includes, but is not limited to, patents (including plant patents, design patents, utility patents and petty patents), patent applications, international patent applications, industrial designs, trademarks, service marks, copyrights, licenses, trade secrets, domain names, confidential information owned by company not publicly known, and any other aspect of IP that gives a company a competitive edge or otherwise enhances the value of a company.

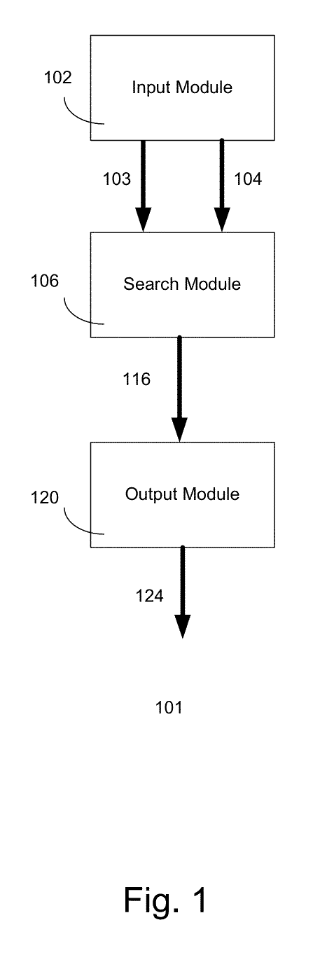

FIG. 1 shows an exemplary system for managing IP. An IP management system 101 includes, in one implementation, an input module 102, a search module 106 and an output module 120. Other configurations are also useful. The input module 102 provides user information 103 and analytical data 104 to the search module 106. The search module searches for an optimal IP portfolio 116 based on the user information and analytical data. The output module 120 processes the optimal IP portfolio and displays the results 124.

The input module comprises, in one implementation, a user server that receives, processes and stores input from the user. The user can interact with the IP management system using client software which may be running within a browser application or a standalone desktop application on the user's personal computer or mobile device. The client software communicates with the user server. The user may provide information regarding the goals to be optimized, such as preferences regarding diversification, expected revenue, budget requirements, initial IP portfolio, target market segments, and other useful information. In addition, the user may provide information about his or her company. This information may be saved in one or more files in the input module.

The goals to be optimized can vary depending on the patent strategy and business goals of the IP portfolio owner. Such goals include, for example, maximizing diversification, maximizing revenue potential, minimizing risks and minimizing costs. The goals can be ranked in accordance with the level of importance, based on the nature of the business. For example, a young startup company born out of ground-breaking inventions should allocate significant resources to obtain protection for the core technology. Diversification may not be such an important factor to such start-up companies, as compared to growing companies, and may be assigned a lower weight than for example, the risk-minimization goal.

The initial IP portfolio can be the current (or existing) portfolio of IP assets which the user's company currently owns. The initial IP portfolio can describe, for example, the number of issued patents, patent applications or a combination of both filed in different countries or jurisdictions. It can also describe the types of technologies that these issued patents or patent applications protect. Technology fields can be classified according to the United States Patent and Trademark Office (USPTO) technology classes. Other types of classification systems, such as the World Intellectual Property Organization (WIPO) International Patent Classification system, can also be used.

In one implementation, the input module further comprises a database server. The database can be a Relational Database Management System (RDMS), such as a Microsoft SQL-Server, Oracle or other suitable systems. In one implementation, the input module serves to validate, refine and process raw source data into analytically useful data. The raw source data may be obtained periodically from, for example, data vendors or commercial databases. The input module provides the search module 106 with access to the validated analytical data 104.

The analytical data 104 comprises, in one implementation, IP market information, such as cost information and market information or indices. Cost information includes, for example, the typical costs of procuring, maintaining or enforcing IP assets in different market segments. The costs include, but are not limited to, professional services fees and official government fees such as filing fees, issue fees, maintenance fees, search fees and examination fees in different jurisdictions or countries. Market information includes, for example, objective market indices that describe the competitive environment of a particular technology or jurisdiction. Such objective market indices can be obtained from public sources such as the Global Competitiveness Report published annually by the World Economic Forum, or computed by consulting skilled professionals.

Based on the user input data 103 and the analytical data 104, the search module 106 searches for an optimal IP portfolio 116 that optimizes at least one goal, after evaluating a number of possible solutions. In one implementation, the search module comprises a search algorithm, such as an informed search algorithm that uses a heuristic to reduce the search space and therefore, increases the efficiency of the search. The informed search algorithm comprises, for example, an evolutionary algorithm (e.g., genetic algorithm), a swarm-based algorithm (e.g., particle swarm optimization and ant colony optimization) or a memetic algorithm. Other types of search algorithms are also useful.

The output module 120, in one implementation, processes and displays the optimal IP portfolio 116. The optimal IP portfolio can be used to, for example, aid the IP manager to manage IP assets in the company, or in making strategic filing and investment decisions. The output module can also automatically provide the user with reports, recommendations or indicators regarding the projected returns on the optimal IP portfolio. For example, based on the user's company's initial and optimal IP portfolios, the output module may provide advice or make recommendations for future actions, such as whether or not to file, acquire or maintain legal protection for a specified invention, where to file the patent application, or which market segment to focus developmental efforts in.

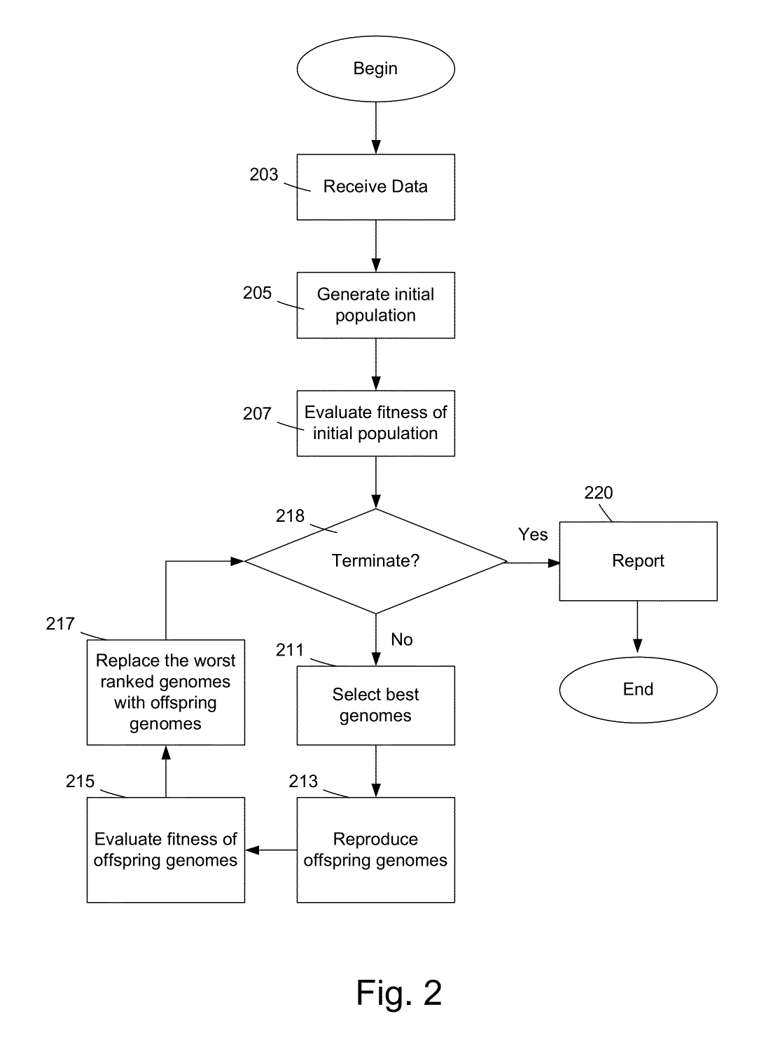

FIG. 2 depicts a flowchart illustrating the operation of an exemplary genetic algorithm in the search module. At step 203, the genetic algorithm begins by receiving user information and analytical data. The initial genome population is then generated at step 205. The genome population comprises a plurality of genomes (e.g., 100). The number of genomes is determined by the resources (e.g., computing power) that are available, and the efficiency desired. Preferably, the number of genomes is selected to enable the genetic algorithm to efficiently and thoroughly search for the optimal IP portfolio. In one implementation, the genome is represented by a vector data structure. One, two or multiple-dimensional vectors can be used. Other types of data structures or implementations are also useful. A genome comprises a plurality of genes (i.e. alleles). A genome represents an IP portfolio. A gene corresponds to a segment of the IP portfolio.

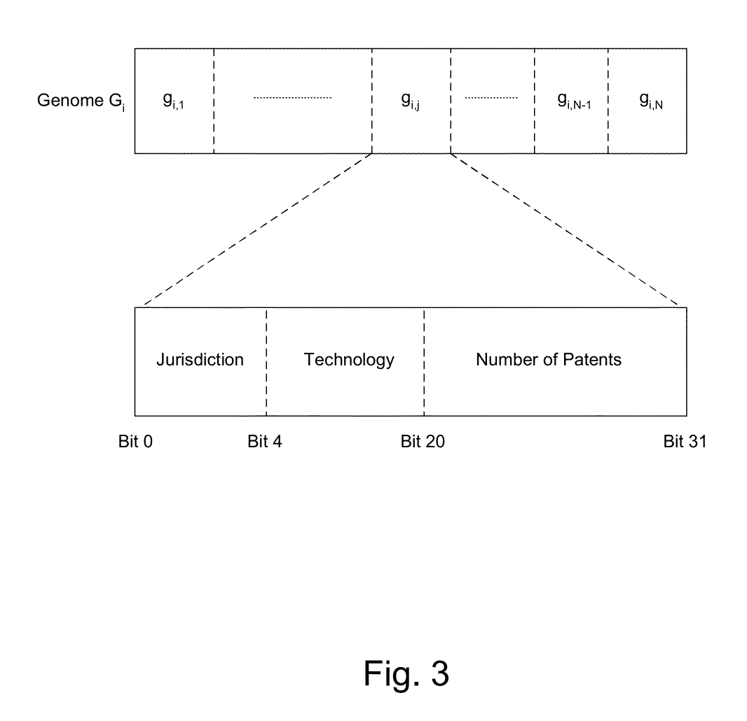

FIG. 3 shows an exemplary genome G. A genome population comprises of M number of genomes G₁, . . . , Gᵢ, . . . G_{M}, wherein M is a positive integer. A genome Gᵢ comprises N number of genes g_{i,1}, . . . g_{i,j}, . . . g_{i,N}, wherein N is a positive integer. In one implementation, the number of genes N is determined by the number of market segments in an IP portfolio to be analyzed.

In one implementation, each gene g_{i,j} represents the number of patents filed in a market segment. The market segment can be defined by, for example, the technology area or the jurisdiction. In one implementation, a jurisdiction is defined by the state (e.g., California, New York), country (e.g., U.S., China, Singapore) or region (e.g., Europe, Asia). In one implementation, a gene represents the number of patents filed in a particular jurisdiction and pertaining to a particular technology. Alternatively, a gene can represent the number of patents filed in a particular technology field. In yet another implementation, a gene represents the number of patents filed in a particular jurisdiction. A combination of different types of genes or other types of configurations are also useful.

A gene can be represented by a 32-bit word, such as the one shown in FIG. 3. Words of other lengths, such as 16, 64, and 124 bits, are also useful. In one implementation, 4 bits (0 to 3) are used to represent the jurisdiction field, 16 bits (4 to 19) are used to represent the technology field and 12 bits (20 to 31) are used to represent the number of patents filed. Other types of bit configurations are also useful. For example, 8 bits (0 to 7) can be used to represent the technology field and 8 bits (8 to 15) can be used to represent the number of patents.

In one implementation, the jurisdiction field contains an unsigned integer X that represents the country that the patents are filed in. A look-up table, such as the one shown in Table 1, can be used to match the integer X to the country.

TABLE 1

| Country | X |
|---|---|
| United States | “0001” (1) |
| China | “0010” (2) |
| Germany | “0011” (3) |
| Japan | “0100” (4) |
| France | “0101” (5) |
| United Kingdom | “0110” (6) |

Likewise, the technology field contains an unsigned integer Y that can be mapped to the technology area using, for example, a lookup table. Alternatively, the integer Y can be mapped to a technology area using a standard classification system, such as the United States Patent Classification System (USPC). For example, following the USPC, (Y=705 or “0000 0010 1100 0001”) represents the data processing technology class. Other types of classifications systems, such as the International Patent Classification (IPC) system, the Japanese Patent Office File Index, the European Patent Classification (ECLA) system or the Derwent Classification system, can also be used. The technology field (e.g., 16 bits) can be subdivided to represent a main class (e.g., 10 bits) and a sub-class (e.g., 6 bits), in accordance with the classification system. Other ways of representing the technology area are also useful.

Referring back to FIG. 2, the genomes are randomly initialized to form the initial population at step 205. In one implementation, the genomes are initialized by randomly assigning 0 or 1 to each bit in the genome with equal probability. In one implementation, the population is generated randomly, covering the entire range of possible solutions. In another implementation, the population is “seeded” where optimal solutions are likely to be found. Other methods of improving the overall quality of search are also useful.

Subsequently, the fitness of each genome is evaluated at step 207. The fitness is determined by using at least one objective fitness function. The fitness function measures how well the genome optimizes or satisfies the specified objective. The number of fitness functions depends on the number of goals K to be achieved. Each fitness function produces a fitness output value fₖ for the specified goal, where k is a positive integer. The fitness value fₖ is preferably normalized to a unitless value wherein 0≦fₖ≦1, to allow for comparison between the different fitness values. Further, the fitness value is preferably standardized, wherein the optimal value is 0 and the worst value is 1. The fitness values may be weighted according to the relative importance of the goals, using a weight factor wₖ wherein 0≦wₖ≦1. To determine the fitness F of each genome, the fitness values corresponding to the various fitness functions are summed as follows:

$$F = {\sum }_{k = 0}^{k = K - 1} {w}_{k} {f}_{k}$$

where

F is the fitness of the genome;

fₖ is the normalized, standardized fitness output value for each objective;

wₖ is the weight for each goal; and

K is the number of goals.

The goals generally depend on the kind of IP strategy that the technology firm adopts. Some firms use their IP to improve their competitive position, generate revenue and/or improve their access to financing. Some objectives may be more important to the firm than others, depending on its nature, size, stage of development or business model. For example, a young firm born of a single ground-breaking invention may want to allocate significant resources to obtain protection for their core technology. The relatively high cost associated with obtaining proper IP protection for certain key technology needs to be balanced against the probability that obtaining such protection could prove vital to the company's attractiveness to investors, ability to secure market share and generate future revenue stream for further growth. Therefore, minimizing cost may be the most important goal, followed by maximizing protection for core technology areas. Maximizing the number of patents may be the least important goal, since cost is generally of the greatest concern for such young companies.

For illustration purposes, some goals are listed below to show the manner in which the fitness of the genomes may be computed. These goals and fitness functions are merely exemplary, and can include other goals or fitness functions not described herein.

### Maximizing the Number of Patents

The fitness value fₖ may be calculated to maximize the number of patents that can be procured within a specified budget. In one implementation, each allele specifies the number of patents (Xⱼ) to be filed within a specified technology or jurisdiction. The fitness value may be calculated, for example, by adding the Xⱼ values of all the alleles in a genome and normalizing the result by using a normalization factor. The normalization factor may be, for example, the maximum number of patents (Xₘₐₓ) obtainable within a specified budget (B). Xₘₐₓ may be calculated, in one implementation, by dividing a specified budget (B) with the average cost of procuring a patent. Other normalization methods may also be used. The following equation illustrates how the fitness of the genome may be calculated:

$${f}_{k} = \vert 1 - \frac{1}{{X}_{max}} {\sum }_{j = 0}^{N - 1} {X}_{j} \vert$$

where

fₖ is the fitness of the genome in optimizing the objective of maximizing the number of patents;

Xₘₐₓ is the maximum number of patents that can be procured using a specified budget;

Xⱼ is the number of patents stated by each allele of the genome; and

N is the number of alleles in the genome.

### Maximizing Protection in Core Technological Areas

In one implementation, the firm may specify certain areas of technology that it wants strong protection. This is done, for example, when the firm adopts a defensive strategy: to prevent copying, prevent other firms from patenting (i.e. blocking) and prevent lawsuits in core technology areas. In one implementation, the search module receives as input the specified technology index indicating the core technology area Tₕ. More than one core technology area may be specified.

For each core technology area, the fitness value f_{k,h} may be calculated, for example, by adding the number of patents (Xⱼ) of all the alleles in a genome directed to the specified technology area. The resulting sum may be normalized by using a normalization factor. The normalization factor can be, for example, the maximum number of patents (Yₕ) obtainable within a specified budget (Bₕ) for a particular technology area. Yₕ may be calculated, in one implementation, by dividing a specified budget (Bₕ) allocated for the specified technology area with the average cost of procuring a patent. Other normalization methods may also be used. The following equation illustrates how the fitness of the genome may be calculated:

$${f}_{k , h} = \vert 1 - \frac{1}{{Y}_{h}} {\sum }_{j = 0}^{N - 1} {X}_{j , h} \vert$$

where

f_{k,h} is the fitness of the genome in optimizing the objective of maximizing the number of patents in a particular core technology area Tₕ;

Yₕ is the maximum number of patents that can be procured using a specified budget allocated for a particular core technology area Tₕ;

X_{j,h} is the number of patents stated by each allele of the genome allocated to the particular core technology area Tₕ; and

N is the number of alleles in the genome.

Where more than one technology area is specified, the fitness value fₖ of the genome can be calculated by obtaining the product of all the f_{k,h} values.

### Maximizing Growth Potential of Patent Portfolio

In one implementation, the firm may want to maintain an international patent portfolio. The patent portfolio can be optimized by filing more patents in countries or technology areas with the highest growth potential. Various factors may affect the growth potential of IP in a certain jurisdiction or technology. For example, factors such as intellectual property protection and enforcement, capacity for innovation, technological readiness or market efficiency may affect the competitiveness of doing business in a particular jurisdiction, which in turn affects the value of procuring an IP asset in that jurisdiction.

Market indices (S) can provide a useful measure of the potential strength of a patent in a particular jurisdiction or industry. In one implementation, the strength of the patent asset in a particular jurisdiction or technology area is represented by an objective market index derived from market data or other objective factors. In another implementation, the index can be a subjective index based on rankings by professionals with the relevant experience. The index S can be provided on a scale of 0 to 10, or similar scale, wherein the higher the value, the greater the potential strength of the IP assets acquired in that jurisdiction or technology. One or more indices can be used. In one implementation, objective market indices comprise jurisdiction indices (S_{c}), technology indices (Sₜ), or a combination of both. Other types of indices are also useful, alone or in combination.

In one implementation, the jurisdiction index describes the environment for protection or enforceability of IP rights in a particular country or the country's technological readiness. Other types of jurisdiction indices are also useful, alone or in combination. In one implementation, the technology objective index describes the market demand for a particular technology. Other types of technology indices are also useful. The objective market indices can be created with indicators such as companies' research and development spending, the creativity of its scientific community, personal computer and internet penetration rates. In one implementation, the market indices are obtained from public sources, such as the Global Competitiveness Report published annually by the World Economic Forum. Alternatively, the objective index can be determined by consulting skilled professionals, such as economists, market analysts, patent practitioners, technologists, attorneys or others with relevant experience to rank the jurisdiction or technology according to potential strength of IP acquired in that area.

In one implementation, the fitness value f_{k,j} of each allele may be calculated, for example, by multiplying the number of patents (Xⱼ) specified by each allele in a genome with the objective index (S) for the specified technology area and/or jurisdiction. The fitness values of all the alleles are added and normalized using a normalization factor. The normalization factor can be, for example, the maximum value of an objective index (Sₘₐₓ). Other normalization methods may also be used. The following equation illustrates how the fitness of the genome may be calculated:

$${f}_{k} = \vert 1 - \frac{1}{{S}_{max}} {\sum }_{j = 0}^{N - 1} {S}_{c} {S}_{t} {X}_{j , h} \vert$$

where

fₖ is the fitness of the genome in optimizing the objective of maximizing the potential of the patent portfolio;

Sₘₐₓ is the maximum value of the objective index;

S_{c} is the objective index of the jurisdiction stated by the allele;

Sₜ is the objective index of the technology area stated by the allele; and

N is the number of alleles in the genome.

### Minimizing Cost of Procuring Legal Protection

The fitness value fₖ may be calculated to minimize the cost of procuring patent protection. In one implementation, each allele specifies the number of patents (Xⱼ) to be filed within a specified technology or jurisdiction. The cost (Cⱼ) of obtaining the number of patents specified in the patent can be calculated by multiplying the number of patents (Xⱼ) with the average cost of preparing and filing the patents in the specified technology or jurisdiction. In one implementation, the average costs of procuring patents in different countries and/or technology areas can be stored in memory and used for computing the average costs Cⱼ.

The fitness value may be calculated, for example, by adding the costs for all the alleles and normalizing the result by using a normalization factor. The normalization factor may be, for example, the specified budget (B). Other normalization methods may also be used. The following equation illustrates how the fitness of the genome may be calculated:

$${f}_{k} = \vert \frac{1}{B} {\sum }_{j = 0}^{N - 1} {C}_{j} \vert$$

where

fₖ is the fitness of the genome in optimizing the objective of minimizing cost;

B is the budget allocated for procuring patents;

Cⱼ is the cost of procuring Xⱼ patents stated by each allele of the genome; and

N is the number of alleles in the genome.

After the fitness (F) of each genome is evaluated, the genomes are selected at step 211 to breed offspring genomes. The fitter genomes are typically more likely to be selected for reproduction. Various types of selection functions may be used. The selection may be carried out, for example, by roulette wheel selection, tournament selection or any other types of suitable algorithms. Most functions are designed such that a small proportion of the less fit genomes are selected to prevent premature convergence on poor solutions.

Reproduction at step 213 is typically carried out by the methods of crossover and mutation of selected “parent” genomes. Various types of crossover techniques can be used to produce the offspring genomes from the parent genomes. For example, crossover techniques such a one-point crossover, two-point crossover, cut-and-splice crossover, uniform crossover and half uniform crossover, are well-known in the art. In one implementation, a one-point crossover technique is used. A crossover point in a pair of parent genomes is selected. All data beyond that point is swapped between the two parent genomes, resulting in two offspring genomes. After the offspring genomes are produced, they are mutated to maintain genetic diversity and avoid a local minima that will produce a sub-optimal solution. This can be done, for example, by selecting an arbitrary bit in the offspring genome and toggling the value from 1 to 0 or vice versa.

By using the methods of crossover and mutation, new genomes are created which shares many of the characteristics of its “parents”. The fitness of each offspring genome is evaluated at step 215. The offspring genome replaces the least fit genome in the population at step 217. Other types of replacement strategies are also useful. This process continues until a terminating condition is reached at step 218.

Different types of terminating conditions can be used. In one implementation, the terminating condition is one of the following: (1) a pre-determined number of generations is reached; (2) the allocated budget is reached; or (3) the highest ranking patent portfolio's fitness is reaching or has reached an optimal level such that successive iterations no longer produce better results. Other types of terminating conditions can also be used, alone or in combination. For example, the process may be terminated when a patent portfolio is found that satisfies a minimum criteria, when manual inspection reveals that further iterations no longer produce better results or when the allocated computing time is reached.

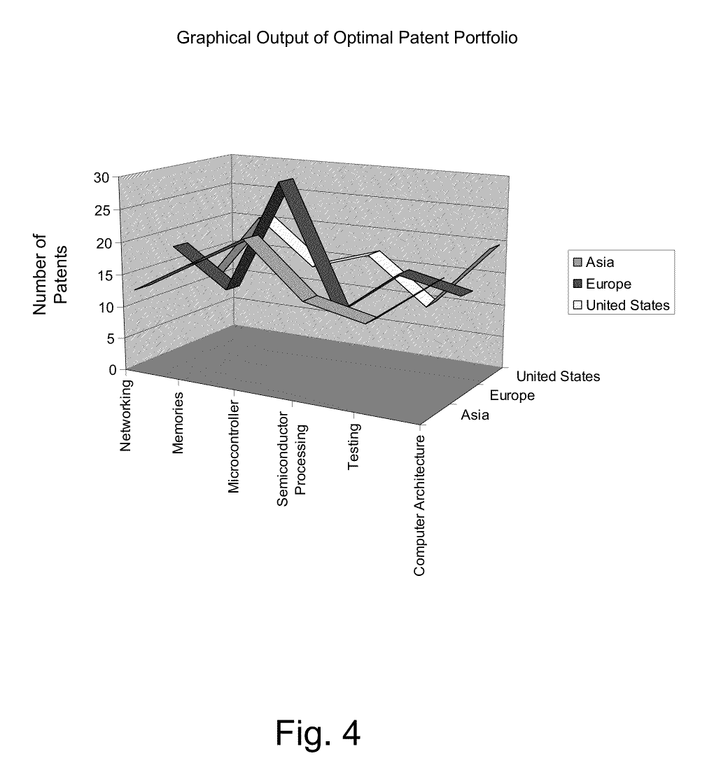

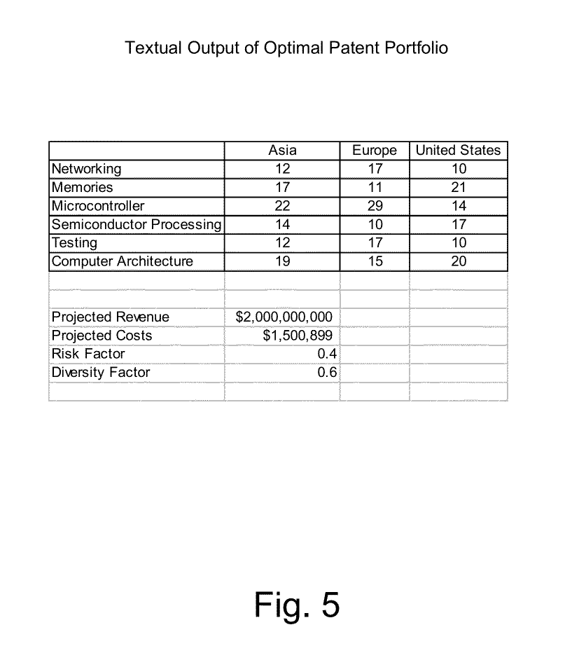

When the terminating condition is satisfied, the results are reported at step 220. The results may be displayed by using any type of user interface, including a graphical display or textual report. By way of example, a graphical output of an optimal patent strategy is shown in FIG. 4. In one implementation, a three-dimensional graph is plotted to show the number of patents to be filed for specified technology areas and countries, in accordance with an optimal patent portfolio solution produced by the search module. FIG. 5 shows another example of how the results can be displayed. The results can be displayed in tabulated textual form. Quality indicators can also be displayed along with the results. For example, the projected revenue, projected costs, risk and diversity indicators, can also be computed from the results and displayed. Other types of output are also useful.

The optimal patent portfolio can be used in a variety of ways. For example, it can be compared with the current (or existing) patent portfolio the enterprise presently owns to provide informed recommendations for IP portfolio management. It can be used to assist IP professionals in making strategic IP decisions, such as decisions with respect to patent application filing and investment in research and development in different technological and geographical areas.

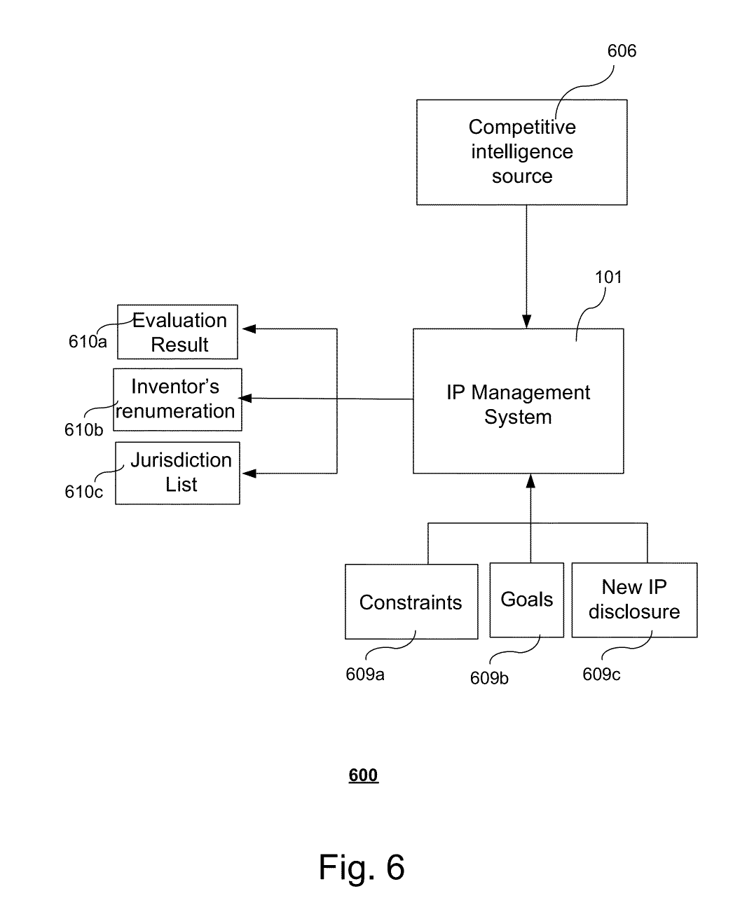

FIG. 6 illustrates an exemplary application 600 of the IP management system 101. As shown, the IP management system 101 receives analytical data from a competitive intelligence source 606. Competitive intelligence generally refers to the gathering and analysis of information about the external business environment (e.g., market trends and industry developments) that allows for advanced identification of risks and opportunities in the competitive arena. It allows an enterprise to understand strategies adopted by competitors in the market, keep informed of emerging market trends, and to determine a strategy to adopt as a reaction and to remain competitive. For example, if the competitive intelligence reveals that a competitor has made many new initiatives and publications in a particular technological field or jurisdiction, a strategic goal may be formulated to increase patent filings in that particular technology field or jurisdiction so as to strengthen its market position and defend against possible law suits. Competitive intelligence information may be used to define strategic goals to be optimized by the IP management system 101.

Exemplary competitive intelligence sources 606 include public domain information sources such as newspaper articles, information databases, internet, trade shows, company publications, journal papers, official publications (e.g., published patent applications and patents, trademarks, designs, etc.), and so forth. Such competitive intelligence sources 606 may also provide general information about the IP market, such as cost information and market information or indices, as previously described. In one implementation, the IP management system 101 includes a web scraping module that extracts information from competitive intelligence sources 606. The web scraping module transforms unstructured data on the web (e.g., hypertext markup language files) into structured data that may be stored and analyzed in, for example, a central local database server. The web scraping module may implement one or more web scraping techniques, such as human copy-and-paste, text grepping, data mining algorithms, and so forth.

The IP management system 101 may further receive user input data, such as constraints 609a, goals 609b, and new IP disclosures 609c. Constraints 609a are conditions that the resulting optimal IP portfolio solution is required to satisfy. Exemplary constraints 609a include budget, preferences (e.g., jurisdiction, technology, type of IP assets preferred), target value of IP portfolio, etc. Goals 609b include, for example, maximizing diversification, maximizing revenue potential, minimizing risks and minimizing costs. Such strategic goals may be formulated based on competitive intelligence, as previously described.

Once the IP management system 101 finds an optimal IP portfolio that optimizes at least one goal, it can provide support to various business or decision-making functions. For example, it can be used to automatically evaluate a new IP disclosure 609c. An IP disclosure 609c generally refers to a report or document written by, for example, an engineer or scientist, for evaluation by the enterprise to determine whether legal protection should be sought for the described IP. The IP disclosure 609c may describe an invention, a design, a trademark, an original work, or any other IP asset.

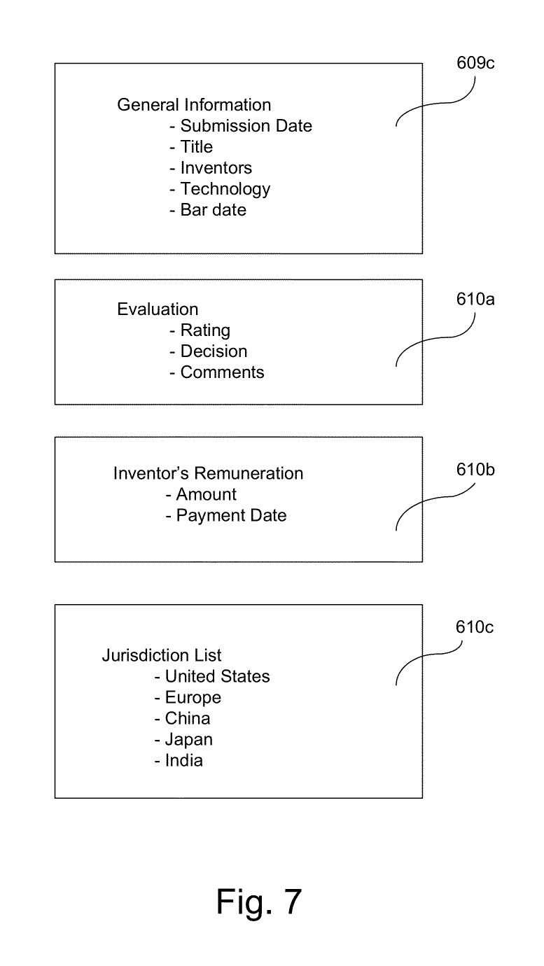

FIG. 7 shows an exemplary IP disclosure 609c, as well as other exemplary reports 610a-c that may be automatically generated by the IP management system 101. As shown, the IP disclosure 609c may be an invention disclosure. The information may include, for example, the submission date, the title, the names of the inventors, description about the technology, any legal bar dates (e.g., date of first sale, date of publication, etc.), and any other relevant information. The IP disclosure 609c may be submitted via, for example, a web-based or mobile client application that communicates with the IP management system 101.

In one implementation, the IP management system 101 automatically evaluates the IP disclosure 609c based on the optimal IP portfolio. In one implementation, the IP disclosure 609c may be evaluated based on one or more differences between the optimal IP portfolio and the enterprise's current (or existing) IP portfolio. The differences may be used to automatically determine one or more strategic steps that the enterprise should take in order to eventually obtain the optimal IP portfolio. If protecting the IP described in the IP disclosure 609c is consistent with at least one of these strategic steps, then the IP disclosure 609c is assigned a good rating. For instance, if the optimal IP portfolio includes more patents in a particular technology field than the current IP portfolio, one of the strategic steps may be to increase patent protection in the particular technology field. If the new IP disclosure 609c describes an invention that falls within that particular technology field, it is automatically assigned a high rating score since obtaining legal protection for such invention is consistent with the strategic step. Other rating factors may also be taken into account when computing the rating score.

The IP management system 101 may also generate other types of recommendations. For example, the optimal IP portfolio may include more patents in particular jurisdictions than the current IP portfolio. As such, a jurisdiction list may be generated to recommend filing for legal IP protection in those countries on the list. As another example, if the optimal IP portfolio includes less patents in a particular technology field than the current portfolio, a report may be generated to recommend abandoning one or more patents or patent applications in that technology field.

As shown in FIG. 6, the IP management system 101 may automatically generate one or more output reports 610a-c after evaluating the new IP disclosure 609c. More particularly, the IP management system 101 may generate an evaluation result report 610a, an inventor's remuneration report 610b and a jurisdiction list 610c. It is understood that other types of reports are also possible. Such output reports 610a-c may be reviewed by, for example, business, technical and/or legal personnel to support their decision making Based on the information and recommendations presented in the reports, the reviewers can make informed decisions whether or not to pursue the recommended steps. For instance, they may decide to accept the recommendation to file for legal protection, and subsequently assign an attorney to prepare the necessary documents.

FIG. 7 illustrates various exemplary output reports 610a-c. As shown, the evaluation result report 610a may include the rating score of the IP disclosure 609c, the recommended decision (e.g., to file or not to file for protection), as well as any other comments (e.g., reasons supporting the recommended decision). The inventor's remuneration report 610b may indicate a suggested amount of payment to the inventor of the IP disclosure 609c, as well as the recommended payment date. The amount of remuneration may be determined at least in part on the rating score, as well as any in-house policy or government regulations. The jurisdiction list report 610b may include a recommended list of countries to file for legal protection of the IP described in the IP disclosure 609c. Other information, such as the associated costs, recommended outside counsels, etc., may also be included.

The present framework may be implemented with any combination of hardware and software. For example, one or more implementations, as described herein, may be described in the general context of computer-executable instructions, such as program modules, executed by one or more computers or other devices. The computer-executable instructions may be stored on some form of computer readable media, a computer program product or any other article of manufacture. The article of manufacture can be included as part of a computer system or sold separately.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for managing a portfolio of intellectual property (IP) assets comprising:
generating an initial population of genomes that represents a set of possible solutions, wherein a genome comprises a plurality of genes and represents a portfolio of IP assets;
searching, within the population, for at least one genome representing an optimal IP portfolio solution that optimizes at least one strategic goal by modifying the population using a genetic algorithm until a terminating condition is satisfied; and
automatically evaluating a new IP disclosure based on the optimal IP portfolio solution.

2. The method of claim 1 wherein the gene represents number of patents filed in a particular market segment.

3. The method of claim 2 wherein the market segment is defined by technology area.

4. The method of claim 2 wherein the market segment is defined by jurisdiction.

5. The method of claim 1 wherein the genetic algorithm comprises:
determining fitness values of the genomes by applying at least one objective fitness function to the genomes, the objective fitness function corresponds to a goal and a fitness value represents the degree to which the strategic goal is satisfied;
selecting parent genomes for reproduction based on their fitness values;
deriving new child genomes from the parent genomes; and
replacing the parent genomes with the child genomes in the population.

6. A computer-implemented method for managing a portfolio of intellectual property (IP) assets, the method comprising:
receiving analytical data and user information;
searching for an optimal IP portfolio based on the user information and the analytical data using an informed search algorithm, wherein the optimal IP portfolio optimizes at least one strategic goal; and
automatically evaluating a new IP disclosure based on the optimal IP portfolio.

7. The method of claim 6 wherein the informed search algorithm comprises an evolutionary algorithm.

8. The method of claim 6 wherein the informed search algorithm comprises a swarm-based algorithm.

9. The method of claim 6 further comprising defining the strategic goal based on analytical data from a competitive intelligence source.

10. The method of claim 6 wherein the strategic goal comprises maximizing number of patents that can be procured with a specified budget.

11. The method of claim 6 wherein the goal comprises maximizing protection of the IP assets in core technological areas.

12. The method of claim 6 wherein the goal comprises maximizing growth potential of the IP assets.

13. The method of claim 6 wherein the goal comprises minimizing cost of procuring legal protection for the IP assets.

14. The method of claim 6 wherein the new IP disclosure comprises an invention disclosure.

15. The method of claim 6 wherein automatically evaluating the new IP disclosure comprises automatically rating the new IP disclosure based on one or more differences between the optimal IP portfolio and a current IP portfolio.

16. The method of claim 6 further comprising automatically generating a jurisdiction list for the new IP disclosure.

17. The method of claim 6 further comprising automatically generating an evaluation result report.

18. The method of claim 6 further comprising automatically generating an inventor's remuneration report.

19. A non-transitory computer-readable medium having stored thereon program code, the program code executable by a computer to:
receive analytical data and user information;
search for an optimal IP portfolio based on the user information and the analytical data using an informed search algorithm, wherein the optimal IP portfolio optimizes at least one strategic goal; and
automatically evaluate a new IP disclosure based on the optimal IP portfolio.

20. A system for managing a portfolio of intellectual property (IP) assets comprising:
a non-transitory memory device for storing computer-readable program code; and
a processor in communication with the memory device, the processor being operative with the computer-readable program code to
receive analytical data and user information,
search for an optimal IP portfolio based on the user information and the analytical data using an informed search algorithm, wherein the optimal IP portfolio optimizes at least one strategic goal, and
automatically evaluate a new IP disclosure based on the optimal IP portfolio.
